(19) United States
(12) Patent Application Publication
(10) Pub. No.: US 2014/0283452 A1
(43) Pub. Date: Sep. 25, 2014

(54) PHOTOSYNTHETIC GROW MODULE AND METHODS OF USE

(71) Applicant: Scott Dittman, Denver, CO (US)

(72) Inventor: Scott Dittman, Denver, CO (US)

(21) Appl. No.: 14/294,937

(22) Filed: Jun. 3, 2014

Related U.S. Application Data
(63) Continuation-in-part of application No. PCT/US12/67610, filed on Dec. 3, 2012.
(60) Provisional application No. 61/566,639, filed on Dec. 3, 2011.

(51) Int. Cl. A01G 31/02; A01G 31/06

(52) U.S. Cl. CPC A01G 31/02; A01G 31/06
USPC 47/62 R

(57) ABSTRACT

A photosynthetic grow module including a fully enclosed ISO container, within which resides a removable cartridge including a lighting system and hydroponic system, is described. The removable cartridges are configured to be readily removed from within an ISO container for planting and harvesting, and readily inserted into an ISO container for growing. The removable cartridges are typically removed from and inserted into an ISO container by use of a fork lift or crane. The photosynthetic grow modules are typically adapted to stack and interlock one atop another, without requiring additional framework or other support structure. Each photosynthetic grow module can include its own heat pump for independent heating and cooling of individual modules, and the units can have a coating within which ceramic microspheres and aluminum flakes are embedded. Lighting systems can include fluorescent lamps combined with LED lamps.

This application is a continuation-in-part of International Application No. PCT/US2012/067610, filed 3 Dec. 2012, which claims priority to U.S. Provisional Application No. 61/566,639, filed 3 Dec. 2011, having the same inventor as the present application, and having the title PHOTOSYNTHETIC GROW MODULE.

This application incorporates by reference in their entirety Application No. 61/566,639, filed 3 Dec. 2011, and International Application No. PCT/US2012/067610, filed 3 Dec. 2012, each having the same inventor as the present application.

### FIELD OF THE INVENTION

The present invention relates generally to modular, enclosed structures for growing green plants under artificial light.

### BACKGROUND

Indoor horticulture offers numerous advantages over outdoor plant cultivation, including greater control of environmental conditions and of growing medium, and increased protection from pests. However, large scale indoor horticulture is hindered because of difficulty with fine-scale control of environmental conditions within large structures. Conditions such as temperature, humidity, CO₂ concentration, and light are difficult to optimize throughout large indoor grow facilities. This is especially true for warehouses, which are typically ill-suited to controlling inside environmental conditions within narrow ranges. Warehouses frequently suffer from relatively leaky envelopes that permit infiltration of outside air and airborne contaminants, as well as allowing inside air to escape, and maintaining optimal conditions within large structures is difficult even with a relatively air-tight, well insulated envelope.

Warehouses can be constructed or retrofitted to improve growing conditions, but often at great expense and with disappointing results. Multiple floors or drop ceilings can be installed within warehouses to produce smaller growing spaces. However, large amounts of space are typically wasted in such installations, and environmental control of individual spaces within the warehouses is still typically far from optimal.

Isolation of certain spaces from other spaces within a warehouse is often desirable for indoor grow facilities. In some instances, plants in a space may need to be isolated from pollen produced by other plants in another space within the warehouse. Similarly, where plants in one space become infested with pests or parasites, other spaces need to be isolated therefrom, and chemical treatment of the infested space may also need to be tightly restricted to that space. Such strict isolation of spaces within a warehouse is extremely difficult to achieve.

Planting and harvesting operations for growing of photosynthetic plants inside relatively confined vessels is awkward and labor intensive. Personnel are often required to reach into relatively inaccessible spaces disposed between levels of indoor growing racks for planting and harvesting. The required awkward stooping and reaching tends to be slow, laborious, and invites fatigue and injury for personnel performing planting and harvesting. In addition, aisles are typically required between growing racks to provide access to personnel for planting, harvesting, and maintenance of equipment. The aisles take up valuable space within the vessels that could otherwise be used for growing. A system utilizing grow modules that provides for more efficient and less back-breaking planting, harvesting, and system maintenance, and that utilizes growing space more efficiently, is needed.

### BRIEF DESCRIPTION OF THE DRAWINGS

FIG. 1 is a side, plan view of a photosynthetic grow module in a warehouse according to an embodiment of the present invention.

FIG. 2 is a perspective view of a grow trough according to an embodiment of the present invention.

FIG. 3 is a cross-section view of a grow trough according to an embodiment of the present invention.

FIG. 4 is perspective view of a grow trough according to an embodiment of the present invention.

FIG. 5 is a perspective view of a photosynthetic grow module according to an embodiment of the present invention.

FIG. 6 is a side, plan view of a photosynthetic grow module according to an embodiment of the present invention, with grow troughs and cartridge plumbing omitted.

FIG. 7 is a side, plan view of a photosynthetic grow module according to an embodiment of the present invention.

FIG. 8 is an end, plan view of a photosynthetic grow module according to an embodiment of the present invention, with grow troughs omitted from the removable cartridge.

FIG. 9 is a perspective view of a removable cartridge according to an embodiment of the present invention, with only two partial levels of grow troughs installed in the removable cartridge and a first end of the removable cartridge visible.

FIG. 10 is a partial, perspective view of the first end of a removable cartridge according to an embodiment of the present invention.

FIG. 11 is a perspective view of a removable cartridge according to an embodiment of the present invention, with only two partial levels of grow troughs installed in the removable cartridge and a second end of the removable cartridge visible.

FIG. 12 is a partial, perspective view of the second end of a removable cartridge according to an embodiment of the present invention.

FIG. 13 is a perspective view of a photosynthetic grow module according to an embodiment of the present invention, with only the base and frame of the removable cartridge illustrated and with cartridge plumbing and grow troughs omitted.

FIG. 14 is a perspective view of a photosynthetic grow module according to an embodiment of the present invention, with only the base and frame of the removable cartridge illustrated, and cartridge plumbing and grow troughs omitted.

FIG. 15 is a perspective view of a photosynthetic grow system according to an embodiment of the present invention.

FIG. 16 is a block diagram of a photosynthetic grow module according to an embodiment of the present invention.

### DETAILED DESCRIPTION

Embodiments of the present invention include self-contained photosynthetic grow modules optimized for growing green plants hydroponically under artificial light within a containment structure. The self contained grow modules provide for highly controlled environment agriculture. The containment structure typically, but not necessarily, comprises an intermodal shipping container meeting ISO 668-1995 standards. Hydroponics and artificial lighting typically reside in or on a removable cartridge. The removable cartridge typically resides within a shipping container during growing of photosynthetic plants, and is configured to be readily removed from within the shipping container for planting and harvesting. The shipping container is typically generic, with the same container or type of container being configured for use growing different types of crops. In contrast, removable cartridges can be crop specific, with one type of removable cartridge configured for optimal growing of, for example red leaf lettuce, and another type of removable cartridge configured for optimal growing of, for example, kale. The various types of crop specific removable cartridges can be used interchangeably with a generic shipping container.

CONTAINMENT STRUCTURE—A typical containment structure includes an ISO container approximately 20 feet or 40 feet long, 8 feet wide, and 8.6 feet tall. Some embodiments are approximately 8.0 or 9.5 feet tall, and ISO containers that are about 10, 20, 30 or 40 feet long are also used. The ISO containers are built to stack and interlock one atop another, without requiring additional framework or other support structure. They are typically adapted to stacking 7 containers high. In some embodiments, reclaimed ISO containers can be repurposed and implemented as a containment structure.

REMOVABLE CARTRIDGES—Embodiments of removable cartridges include support assemblies on which reside hydroponic systems and light sources. The support assemblies typically include a frame residing on a base. The hydroponic systems include grow troughs plumbed to receive nutrient broth, and also plumbed to drain the broth therefrom. The multiple grow troughs are typically supported on each of multiple levels of the frame. The removable cartridge typically resides within a containment structure for growing photosynthetic plants, and is removed from within containment structure for planting plants in the grow troughs and also for harvesting. The frames typically include channels residing within frame members, the channels being configured to deliver air, carbon dioxide supplemented air, or other gas, to various points about the frame. The air or other gases are typically emitted from within the channels through gas apertures residing at various points on the frame.

HEATING, COOLING, AND INSULATION—Photosynthetic grow modules are typically, but not necessarily, heated or cooled by an electrically powered heat pump, with each individual grow module equipped with its own heat pump. As is recognized by persons skilled in the art, a heat pump is designed and adapted to provide both heating and cooling to a space (in this case a photosynthetic grow module) served by the heat pump. The heat pumps are typically highly efficient (18 SEER or better) mini-split wall mounted air conditioner/heat pump. 3,500 BTUs of cooling capacity for each 1000 watts of lighting within the containment vessel are typically used. The heat pump/air conditioners naturally remove moisture from the air. An additional de-humidifier can be installed to remove additional moisture.

Sensors for detecting containment vessel interior parameters including air temperature, relative humidity, CO₂ concentration, nutrient broth parameters (pH, temperature, nutrient PPM or EC level) are typically installed in containment vessels along with light meters and light timers. Parameters are monitored and in some cases adjusted by use of a central growth management system custom configured by AgrowTek, (Chicago, Ill.). Remote monitoring is typically performed by computer or smart phone. Email alerts are typically used for out of range parameters

Photosynthetic grow modules can include an insulating coating comprising ceramic micro spheres having a low pressure interior cavity. The ceramic microspheres are embedded in a coating such as, but not limited to, paint, enamel, lacquer, epoxy, and polyurethane. The ceramic microspheres can be applied to an inside or outside surface of a grow module, or both an inside and outside surface. The ceramic microspheres provide a barrier to conductive heat flow in a thin film. Accordingly, valuable space inside the grow module is typically not used for insulation. In some embodiments, a barrier to radiant heat flow is achieved with an aluminized coating. Variations include insulating coatings comprising both the ceramic microspheres and aluminum flakes. Embodiments include Barrier Coat #85 from Hy-Tech Thermal Solutions, LLC (Melbourne, Fla.).

HYDROPONIC SYSTEMS—Photosynthetic grow modules typically include a hydroponic system for growing plants in a nutrient broth rather than in soil. The nutrient broth is typically pumped from a reservoir to a grow trough, where plants growing in and extending from the trough have their roots bathed in the nutrient broth. After bathing the plant roots, the nutrient broth is typically returned to the reservoir. Accordingly, the nutrient broth is typically recirculated. Water and plant nutrients can be added to the recirculating nutrient broth in order to achieve or maintain a desired broth composition (PH of water and EC/PPM of nutrients can be adjusted). In some instances, including but not limited to instances where the nutrient broth has become too high in salts, plant metabolites, or other constituents, a portion of nutrient broth may be discharged from a photosynthetic grow module. Variations of the hydroponic systems include growing troughs having multiple channels through which the nutrient broth or other liquids are delivered to the plants. The multiple channels are typically, but not necessarily, layered one on top of another, and may comprise or consist essentially of polyethylene. In some embodiments, grow troughs from New Growing System S.L. (Pulpi, Spain) are used.

AEROPONIC SYSTEMS—Photosynthetic grow modules can include an aeroponic system for growing plants in an air and/or mist environment rather than soil. A nutrient broth is typically pumped from a reservoir to a plurality of nozzles, where plants growing in and extending from a support structure have their roots sprayed with the nutrient broth. After spraying the plant roots, the nutrient broth is typically returned to the reservoir. Accordingly, the nutrient broth is typically recirculated. Water and plant nutrients can be added to the recirculating nutrient broth in order to achieve or maintain a desired broth composition (PH of water and EC/PPM of nutrients can be adjusted). In some instances, including, but not limited to instances where the nutrient broth has become too high in salts, plant metabolites, or other constituents, a portion of nutrient broth may be discharged from a photosynthetic grow module.

LIGHTS—Embodiments of photosynthetic grow modules include artificial light sources that eliminate the need for natural sunlight, and enable light cycles of varied duration. In some embodiments, light cycles of up to 18 hours or more per day are utilized. Artificial light sources include, but are not limited to, high intensity discharge lamps (HIDs), high pressure sodium lamps (HPSs), fluorescent lamps, and light emitting diodes (LEDs). High intensity discharge lamps and high pressure sodium lamps typically produce a relatively large quantity of heat and must be separated from plants by at least 30 inches in order to prevent heat stress or burning of the plants. Fluorescent lamps are more efficient and produce less heat than high intensity discharge lamps but may emit a less beneficial light spectrum than the high intensity discharge lamps. LED light sources are generally more efficient than fluorescent lamps and generate even less heat. In some embodiments, light is provided by GreenPower™ LED modules from Royal Philips Electronics (Amsterdam, The Netherlands). LED sources can emit a relatively high light output in deep red wavelengths, blue wavelengths, far red wavelengths, mixes of deep red and blue wavelengths, mixes of deep red and white wavelengths, and other electromagnetic radiation wavelengths that can be beneficial for promoting vegetative growth, flowering, or other stages of plant growth or development. Embodiments include light assemblies comprising both fluorescent lamps and LEDs. In some embodiments, a digital ballast can be implemented with the light assemblies.

FILTRATION AND AIR EXCHANGE—Embodiments of photosynthetic grow modules include filters for incoming or outgoing air. The filters can include high efficiency particulate (HEPA) and organic compound filtration elements. Organic compound filtration elements typically comprise activated carbon, and are sometimes used in order to remove the smell from air exhausted from grow modules where odoriferous crops are cultivated. Organic compound filtration of incoming air is also advantageous where the air is contaminated by engine exhaust or other undesirable contaminant. HEPA filtration can prevent or reduce introduction of unwanted pollen or pests into a photosynthetic grow module, and also prevent exhaust of airborne pollen. Where a grow module has been infested with pests or parasites and chemical treatment is required, organic compound filtration can prevent the chemical treatment from escaping the module. In some embodiments, a heat exchanger is installed to reduce undesirable transmission of heat into or out of a grow module as outside and inside are across the grow module envelope.

ORGANIC—Embodiments of photosynthetic grow modules include certified organically grown food crops or other plants. The enclosed structure facilitates exclusion of pests and parasites, abrogating a need for pesticides that contravene requirements for organic certification. Organic nutrient broth used instead of soil eliminates an extended interval of organic treatment of crops before the soil in which the crops are grown can be certified organic. In some embodiments, a photosynthetic grow module can be certified organic prior to transferring the grow module to a new location, or to a new owner or operator, such that the grown module does not require additional certification upon completion of the transfer.

WAREHOUSING OF MULTIPLE GROW MODULES—In some systems, multiple photosynthetic grow modules are installed inside a warehouse. The warehouse provides for gross level environment control and protection from weather, as well as a security for limiting access to the grow modules. The grow modules are typically, but not necessarily, stacked inside the warehouse in order to make the most of floor area and total warehouse volume. ISO containers are adapted to stack as many as six additional ISO containers atop a bottom container (total stacking=7 high) without requiring a framework or other support structure other than the ISO containers themselves. External stairs, elevators, or scaffolding are typically required to provide access to stacked photosynthetic grow modules.

UNDERGROUND INSTALLATION—Embodiments of photosynthetic grow modules can be installed underground. The ability of ISO containers to support enormous loads allows the containers to be buried underground with little concern about the module being crushed, although care must be taken to have the frame of the container carry any load placed atop the container. Grow modules installed underground are relatively well buffered against temperature extremes that frequently occur above ground.

METHODS OF DOING BUSINESS USING PHOTOSYNTHETIC GROW MODULES—In some methods of doing business, different entities can have an ownership interest in different photosynthetic grow modules within a single warehouse or other secure location. Ownership interests can include, but is not limited to, leasing, renting, or outright purchase of the entire ownership interest in a grow module. Accordingly, the grow modules can be managed in a manner similar to that of apartments or condominiums, with the individual renters, lessees, or owners having responsibility of conduct or performance within their grow modules, and the business owner having responsibility for maintaining the warehouse or other facility within or on which the grow modules reside.

In some methods of doing business, the business owner obtains certification for a prescribed use of a photosynthetic grow module, and a subsequent owner or operator of the grow module enjoys the benefit of that certification. The certification can be provided by a private sector or government entity. The government entity can be a federal, state, or local government entity, in the United States of foreign country. Certification can include, but is not limited to, organic certification by CCOF, organic certification by the United States Department of Agriculture (USDA), organic certification under the Canada Organic Regime of the Canadian Food Inspection Agency, permits or certification by United States federal, state, or local governments for growing marijuana or other controlled crops for medical or research purposes.

Embodiments of photosynthetic grow modules are very physically robust and are thus relatively easy to make very secure against unauthorized entry. They have heavy gauge corrugated steel walls, no windows, and heavy duty doors that are extremely resistant to being forced open without being unlocked or unlatched. Accordingly, a securely locked grow module is relatively impenetrable. Their security makes the grow modules well suited to the “apartment or condominium” model of individual ownership interest described above. Access into a warehouse can be automated and only moderately secure, and individual grow modules contained therein can still enjoy very high security. Variations of photosynthetic grow modules are equipped for video monitoring of all activity inside the module, and access logs can further monitor anyone who enters the module. The video monitoring, access logs, and relative invulnerability to forced entry can be beneficial or essential to accruing some permitting or certification as described above.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The term “generally,” as used in this specification and appended claims, mean mostly, or for the most part.

The term “fertigation system,” as used in this specification and appended claims, refers to an application of fertilizers, soil amendments, or other water-soluble products to a plants through an irrigation system.

The terms “broth,” or “nutrient broth,” as used in this specification and appended claims, refers to a liquid comprising plant nutrients. The liquid is designed for and adapted to be delivered to plants cultivated hydroponically. The liquid can be a solution, heterogeneous mixture, homogeneous mixture, emulsion, suspension, or combination thereof. The nutrient broth is typically delivered to plant roots by a hydroponic trough or similar hydroponic delivery means. In some variations, the nutrient broth can be administered to plants by foliar feeding.

The terms “stack,” “stacked,” “stacking,” “stackable,” and similar terms, as used in this specification and appended claims, refers to photosynthetic grow modules installed one or more atop another, or adapted to such installation, without requiring additional framework, structural support, or the like. In order to be stacked or stackable, a photosynthetic grow module must be adapted to support at least one similar self-contained grow module with a gross-weight of at least 20,000 lbs. A stacked or stackable photosynthetic grow module is adapted to interlock with another stacked or stackable photosynthetic grow module installed thereupon, in order to securely link the two modules together. Photosynthetic grow modules comprising ISO containers are inherently stackable.

The terms “supple,” “substantially supple,” “supple material,” and similar terms, as used in this specification and appended claims, refer to pliant or flexible material that yields, folds, or bends with little resistance and without breaking Supple material typically yields, folds, or bends without deforming permanently.

Directional or relational terms such as “top,” “bottom,” “upwardly,” “downwardly,” “above,” “below,” “inside,” “outside,” “upper,” “lower,” and “horizontal,” as used in this specification and appended claims, refer to relative positions of identified elements, components or objects, when photosynthetic grow module and its constituent parts reside upright.

The term “light,” as used in this specification and appended claims, refers to electromagnetic radiation falling within the ultraviolet, visible, or infra-red regions of the electromagnetic spectrum.

The term “ISO container,” as used in this specification and appended claims, refers to a fully enclosed (no open top or platform) steel structure meeting International Organization for Standardization 668-1995 (ISO 668) specifications, and adapted to use as intermodal freight containers. ISO containers identified by their nominal length can have the following dimensions (plus or minus 4%).

| NOMINAL | ACTUAL | ACTUAL | ACTUAL | INTERNAL |
|---|---|---|---|---|
| LENGTH | LENGTH | WIDTH | HEIGHT | VOLUME |
| 40′ | 40′ | 8′ 0″ | 8′ 0″ | 2232 ft³ |
| 30′ | 29′ 11.25″ | | | 1663 ft³ |
| 20′ | 19′ 10.5″ | | | 1094 ft³ |
| 10′ | 9′ 9.75″ | | | 469 ft³ |
| 40′ | 40′ | | 8″ 6″ | 2384 ft³ |
| 30′ | 29′ 11.25″ | | | 1777 ft³ |
| 20′ | 19′ 10.5″ | | | 1169 ft³ |
| 10′ | 9′ 9.75″ | | | 501 ft³ |
| 40′ | 40′ | | 9′ 6″ | 2662 ft³ |
| 30′ | 29′ 11.25″ | | | 1984 ft³ |
| 20′ | 19′ 10.5″ | | | 1305 ft³ |
| 10′ | 9′ 9.75″ | | | 559 ft³ |

### A First Embodiment Photosynthetic Grow Module

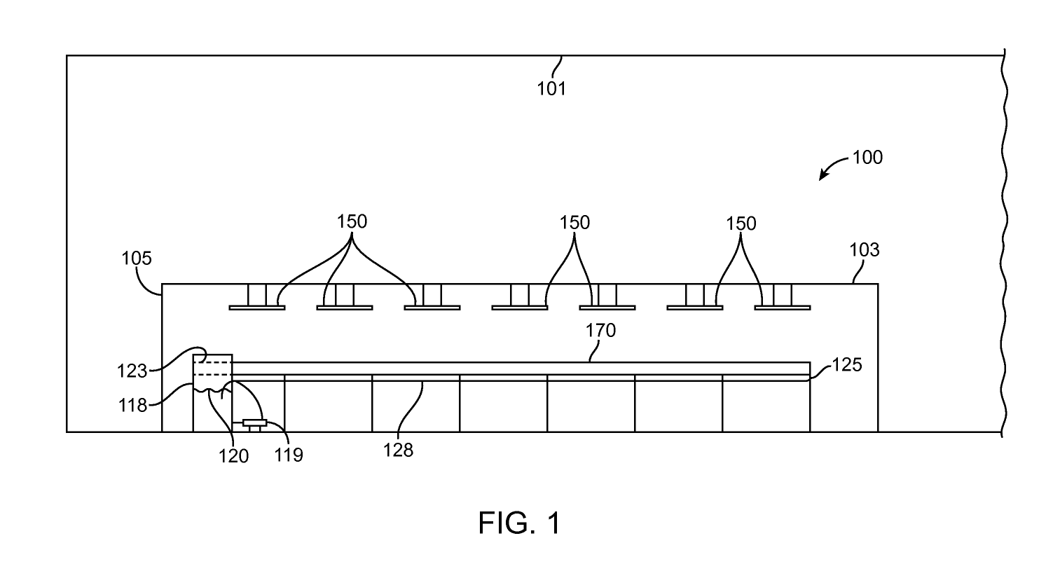

A side orthogonal view of a first embodiment photosynthetic grow module 100 residing in a warehouse 101 is illustrated in FIG. 1. The first embodiment photosynthetic grow module 100 includes a containment structure 103 comprising a 40 foot steel ISO container having external dimensions of approximately 40 ft long, 8 ft wide, and 8 ft tall, and having an internal cavity with a volume of approximately 2232 ft³. The containment structure 103 is fully enclosed, with swinging doors 105 at a first end providing access to the internal cavity. The first embodiment photosynthetic grow module is coated inside and out by a polyurethane enamel comprising insulating microspheres.

The photosynthetic grow module further comprises a hydroponic system including a grow trough 170 and a liquid reservoir 118. The grow module includes multiple grow troughs, each of which is approximately 32 feet long, but only one grow trough is visible in FIG. 1. A liquid pump 119 delivers nutrient broth 120 from the reservoir 118 to the grow trough 170, and the nutrient broth flows by force of gravity from a trough first end 123 to a trough second end 125, the grow trough having a slope of about 0.25″ per foot. The nutrient broth flows back to the liquid reservoir through a return line 128, which slopes downwardly back to the liquid reservoir.

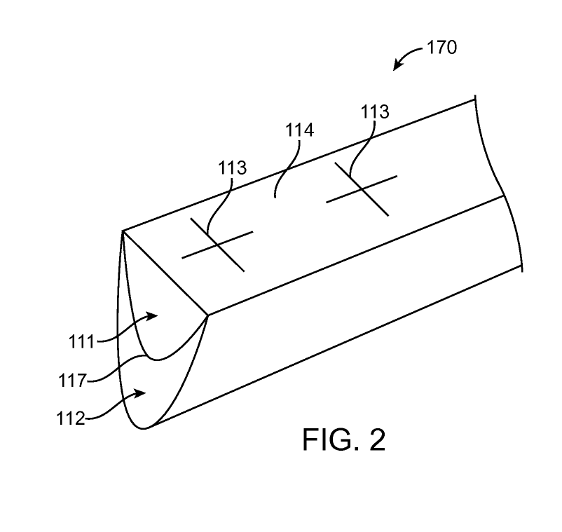

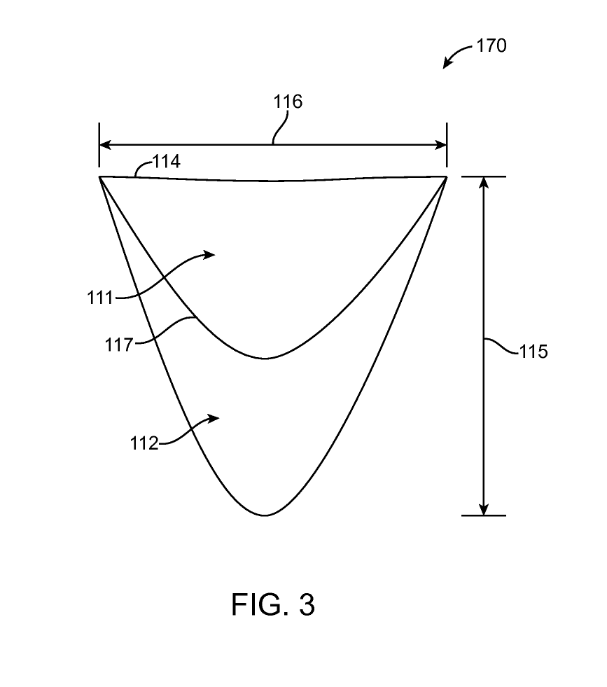

As best seen in FIGS. 2 and 3, the grow trough 170 of the first embodiment grow trough includes an upper grow channel 111 residing above a lower grow channel 112. Plant apertures 113 reside in a top sheet 114, and are typically, but not necessarily, spaced approximately every 3.9 inches on center along the trough. A medial sheet 117 separates the first and lower grow channels, and medial sheet apertures (not shown) provide a means for nutrient broth or other liquid to drain or flow from the upper grow channel down into the lower grow channel. The grow trough consists essentially of supple polyethylene that can be wound to or unwound from a spool. The supple polyethylene lies substantially flat when the grow trough is wound onto a spool. As best seen in FIG. 3, the grow trough of the first embodiment photosynthetic grow module has a trough height 115 and a trough width 116 of approximately 4.7 inches when in a deployed configuration, i.e. not laying flat. Other embodiments include grow troughs having different heights and widths, and comprising or consisting essentially of polymers including, but not limited to, nylon, polyvinyl chloride (PVC), acrylonitrile butadiene styrene (ABS), polyethylene terephthalate (PET), polyetheretherketone (PEEK), polyimide, polycarbonate, polyaniline, acrylate or methacrylate polymers, fluorinated polymers such as polytetrafluoroethylene or polyfluoroethylenepropylene, and polyolefins such as polyethylene (PE), polypropylene (PP) or polybutylene (PB).

The photosynthetic grow module further comprises a light system including multiple light sources 150. Each of the multiple light sources comprises an LED assembly emitting electromagnetic radiation that can include, but is not limited to, white light, deep red light, far red light, and blue light. In some embodiments the LED assemblies emit mostly white light, or a mix of white light and deep red light, or a mix of deep red and blue light.

A method of using the first embodiment photosynthetic grow module includes growing 2100 heads of leafy greens every 26 days. Another method of use includes producing 4200 heads of baby lettuce every 17 days. Yet another method of use includes growing 4200 heads of basil in 17 days.

### A Second Embodiment Photosynthetic Grow Module

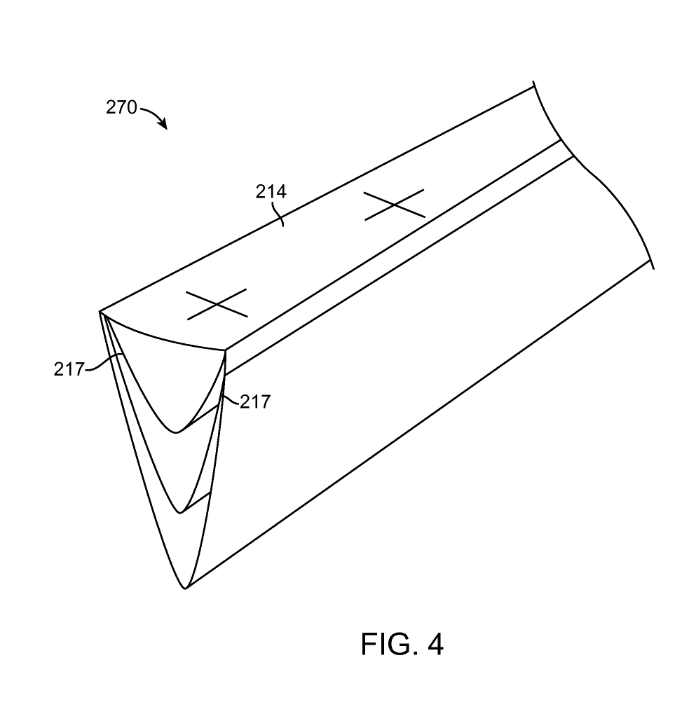

A multi-channel grow trough 270 from a second embodiment photosynthetic grow module is illustrated in FIG. 4. The second embodiment grow trough 270 comprises a top sheet 214 and three vertically layered channels separated from one another by medial sheets 217. The medial sheets comprise apertures incorporated therein (not shown) in order to permit nutrient broth or other liquid to drain or flow downwardly from a channel down into a channel residing below.

### A Third Embodiment Photosynthetic Grow Module

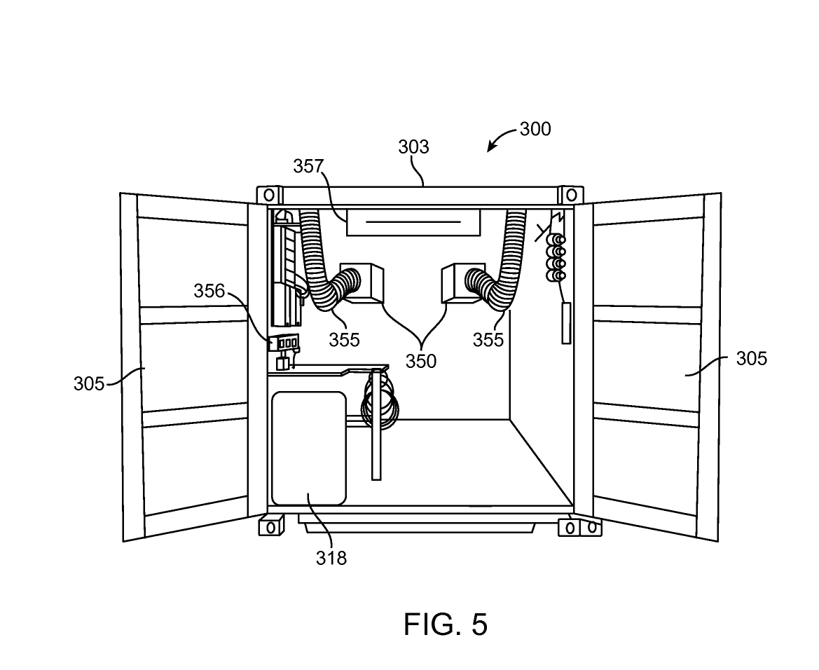

An end view of a third embodiment photosynthetic grow module 300 is illustrated in FIG. 5. The third embodiment photosynthetic grow module 300 includes a containment structure 303 comprising a 40 foot steel ISO container having external dimensions of approximately 40 ft long, 8 ft wide, and 8 ft tall, and having an internal cavity with a volume of approximately 2232 ft³. The grow module 300 is fully enclosed, with swinging doors 305 at a first end providing access to the internal cavity. The third embodiment grow module 300 typically includes a heat pump 357 for heating and cooling the containment structure interior, and the containment structure 303 typically includes electric outlets 356 as a source of electric power.

The third embodiment photosynthetic grow module 300 includes an interior coating comprising ceramic microspheres having a low pressure internal cavity and aluminum flakes, both of which are embedded in latex paint. The ceramic microspheres conduct heat extremely poorly and the aluminum flakes are highly reflective of infra-red electromagnetic radiation. Accordingly, the interior coating of the third embodiment photosynthetic grow module acts as an efficient heat conductive barrier and radiant barrier.

The third embodiment photosynthetic grow module 300 further comprises a light system including multiple light sources 350. Each of the multiple light sources comprises a high intensity discharge lamp. The light system further comprises light ventilation ducts 355 for removing heat generated by the high intensity discharge lamps. The high intensity discharge lamps can be hard-wired for delivery of electric power, or can be plugged into adequately powered electric outlets.

The photosynthetic grow module further comprises a liquid reservoir 318 adapted to contain nutrient broth for hydroponic cultivation of green plants in the grow module.

### A Fourth Embodiment Photosynthetic Grow Module

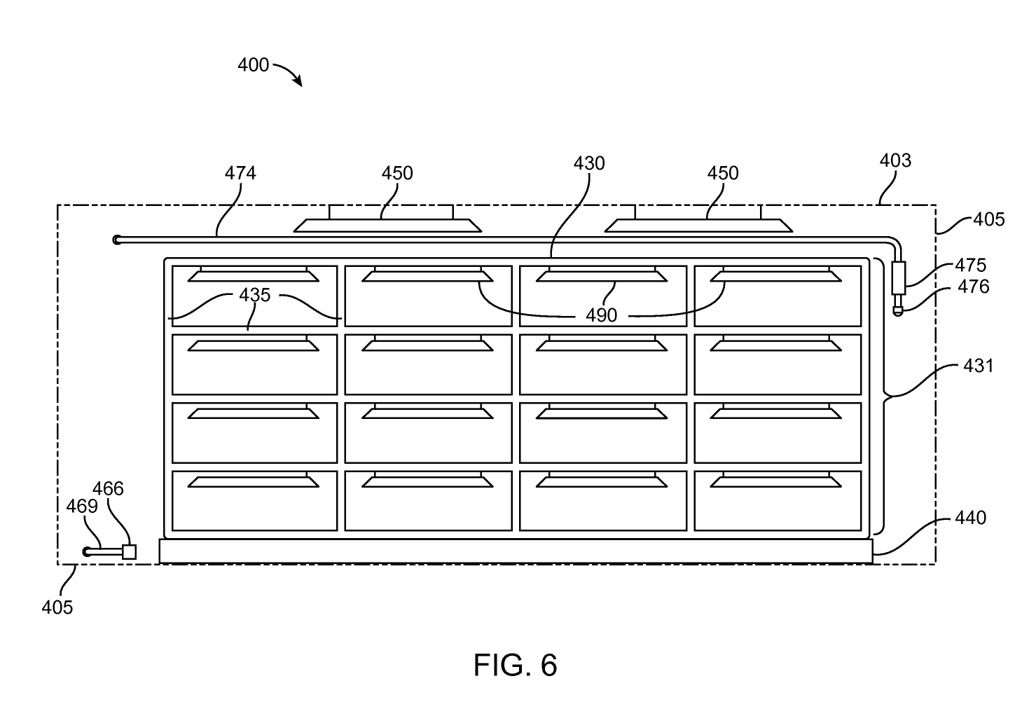

A fourth embodiment photosynthetic grow module 400 is illustrated in FIGS. 6-13. Because illustration of an entire assembled fourth embodiment grow module 400 would be confusingly complex, the fourth embodiment grow module and its components are illustrated in FIGS. 6-13 as follows. FIG. 6 is a side plan view showing a removable cartridge 430 installed in a containment vessel 403, but the removable cartridge 430 is shown without grow troughs 470, cartridge liquid distribution plumbing, or a cartridge drain assembly 435. The cartridge base 440, frame 431, cartridge light fixtures 490, and channels 435 are shown in FIG. 6.

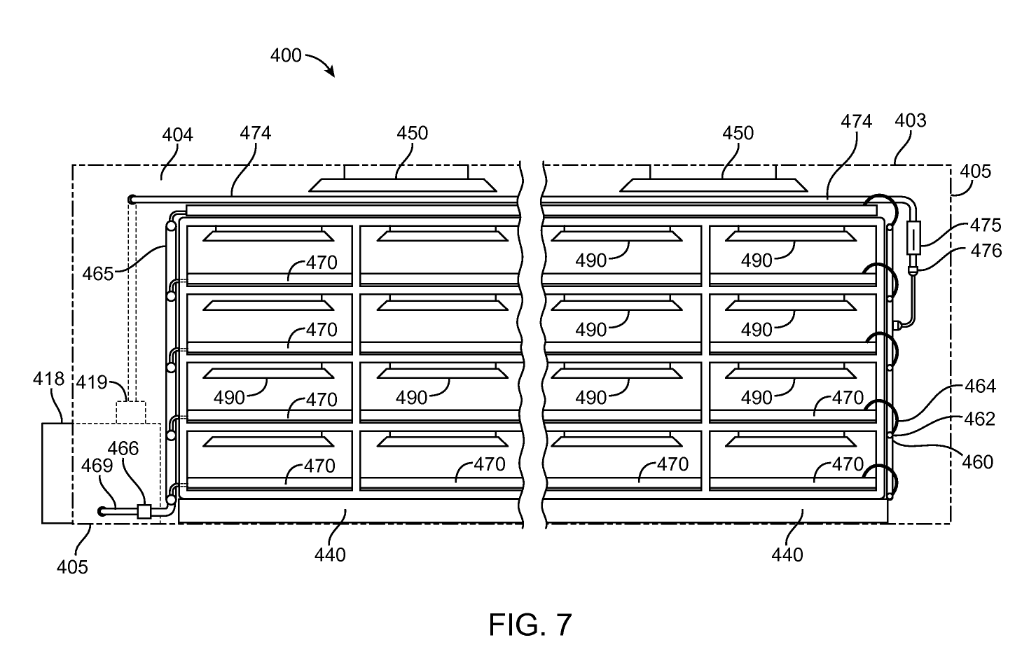

FIG. 7 shows a side, plan similar to that of FIG. 6, including the removable cartridge 430 in the containment vessel 403, with the grow troughs 470, cartridge drain assembly 465, and the cartridge liquid distribution plumbing illustrated. The cartridge liquid distribution plumbing includes liquid conduits 460, liquid distribution manifolds 462, and liquid distribution tubes 464.

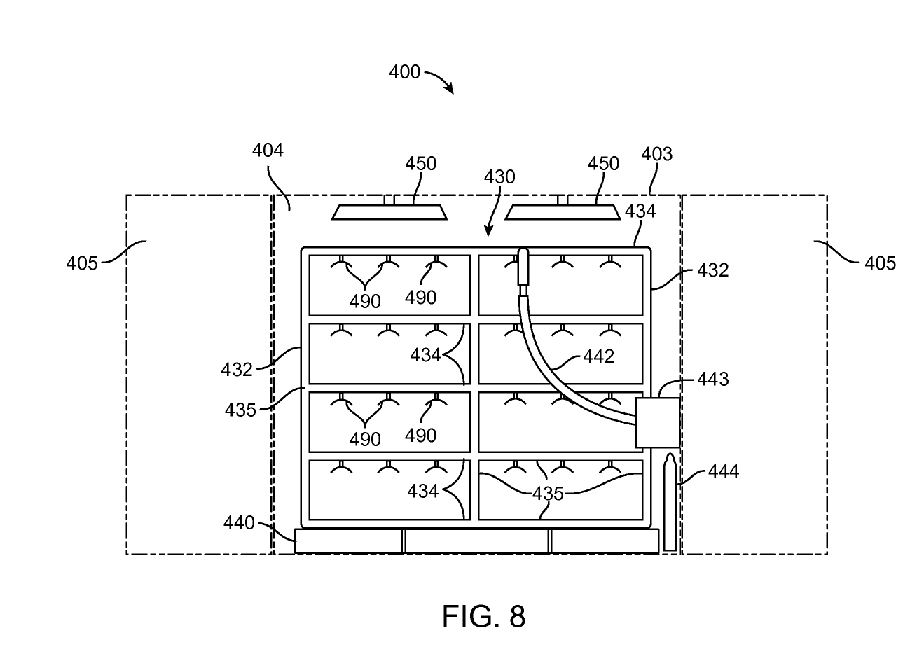

FIG. 8 shows an end, plan view of the removable cartridge 430 residing in the containment vessel 403. The cartridge liquid distribution plumbing and the cartridge drain assembly are omitted in FIG. 8.

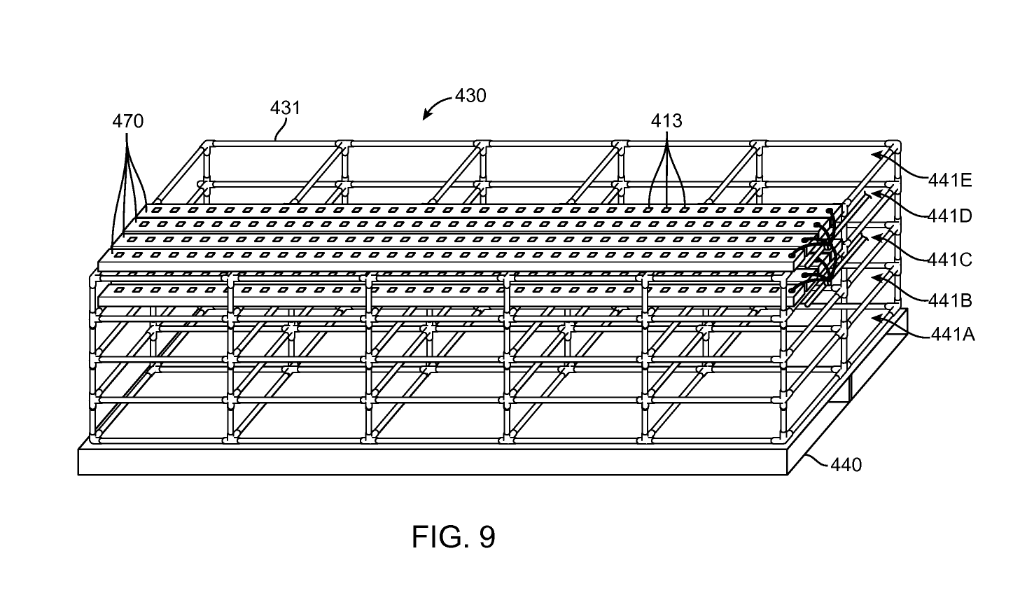

FIG. 9 shows a perspective view of a partially assembled removable cartridge 430, including grow troughs 470, frame 431, and base 440. The view illustrated in FIG. 9 is from the first end, with the cartridge liquid distribution system partially shown.

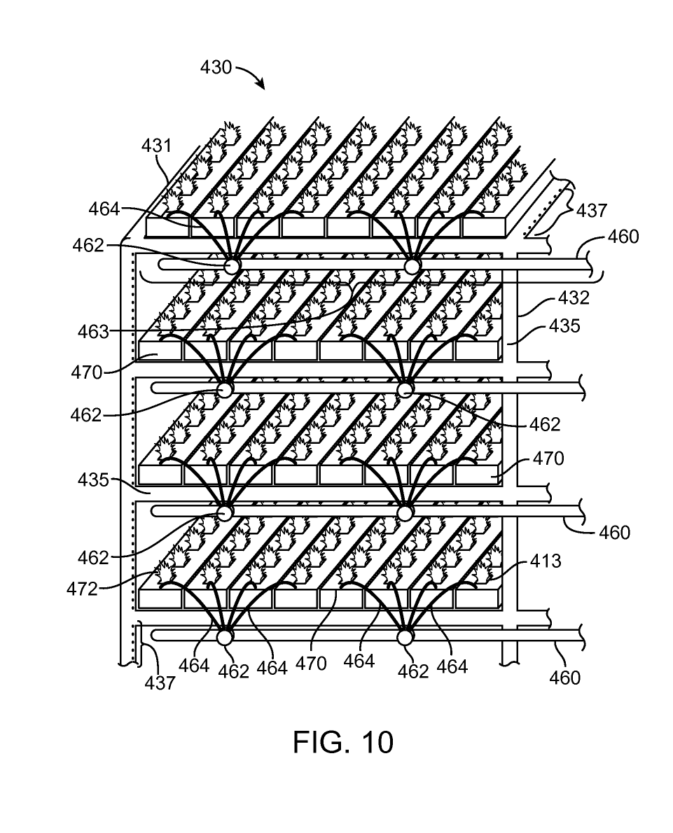

FIG. 10 shows a perspective view of the first end of the removable cartridge 430, including plants 470, grow troughs 470, cartridge light fixtures 490, and the cartridge liquid distribution system. The liquid distribution system comprises the liquid conduits 460, liquid distribution manifolds 462, and liquid distribution tube 464.

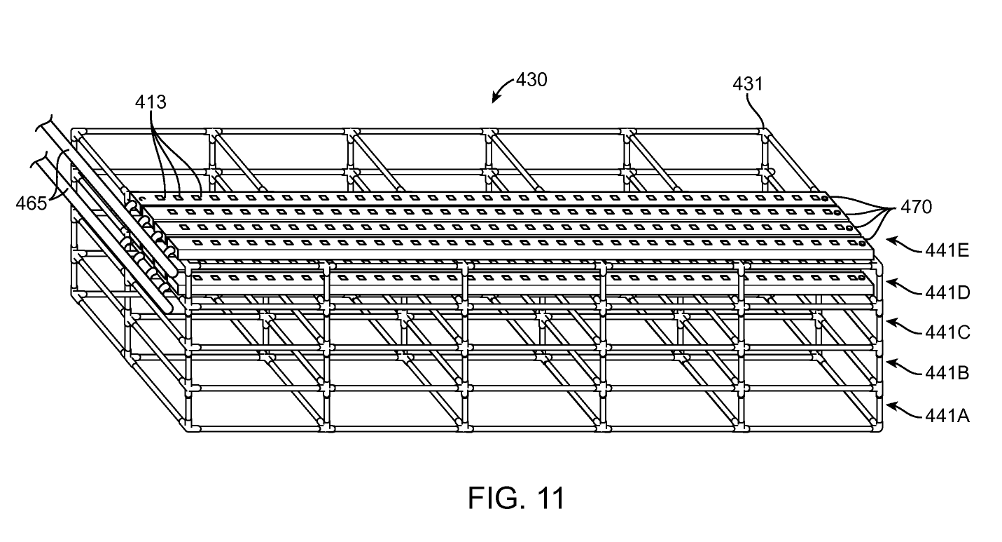

FIG. 11 shows a perspective view of a partially assembled removable cartridge 430, including grow troughs 470 and frame 431. The view illustrated in FIG. 11 is from the second end, with the cartridge drain assembly 465 partially shown.

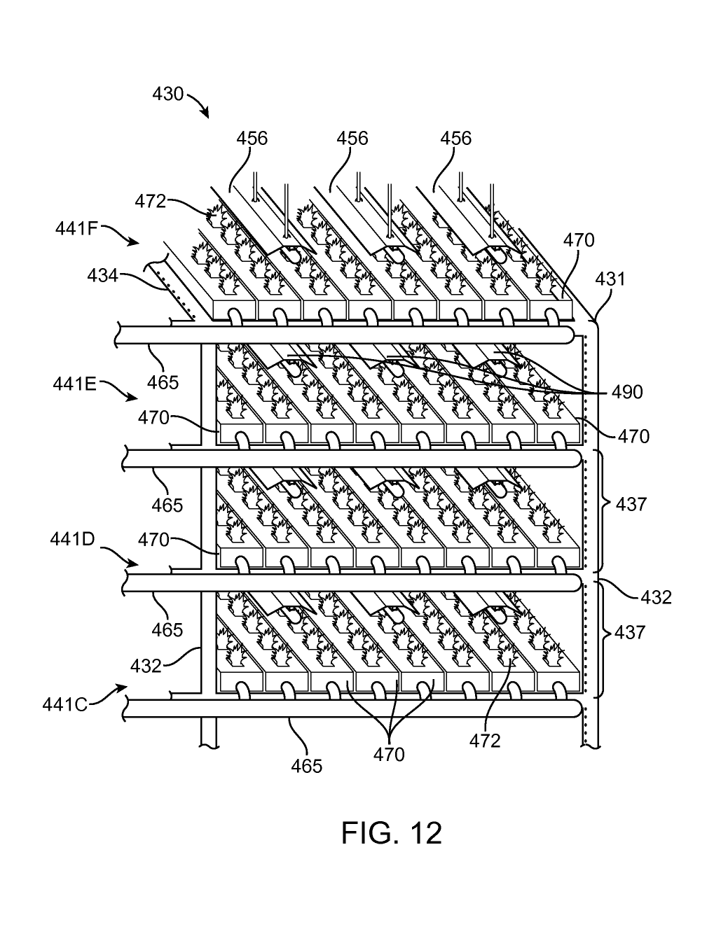

FIG. 12 shows a perspective view of the second end of the removable cartridge 430, including grow troughs 470 and the cartridge drain assembly 465. Container light fixtures 456 are also shown in FIG. 10, seen suspended above the removable cartridge 430.

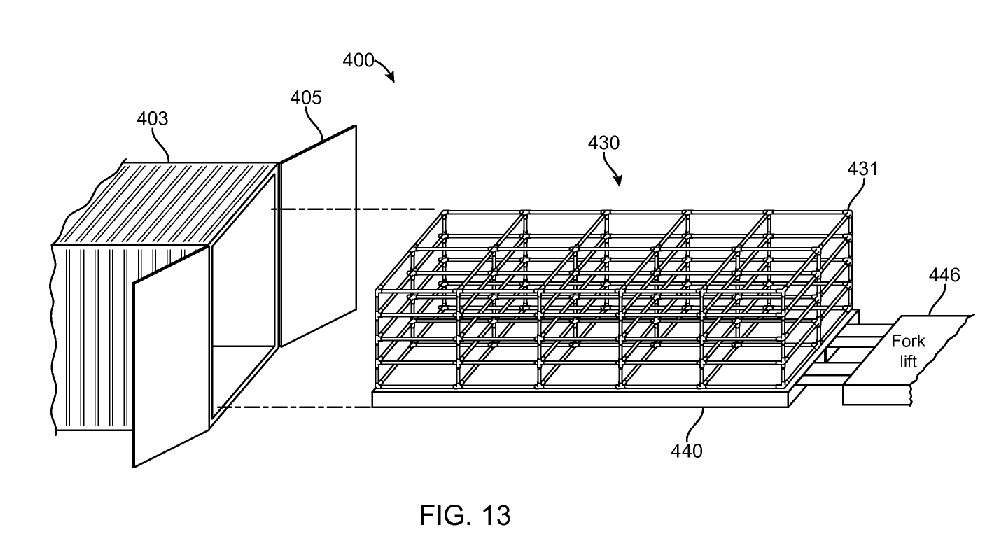

FIG. 13 shows a removable cartridge 430 after removal from within a containment vessel 403 by use of a fork lift 446. The removable cartridge 430 is illustrated without any of the hydroponic system components. Accordingly, only the cartridge base 440 and frame 431 are illustrated in FIG. 13.

The fourth embodiment grow module 400 comprises a containment structure 403 within which resides a removable cartridge 430. The containment structure 403 is typically a 20 foot steel ISO container having external dimensions of approximately 20 ft long, 8.0 ft wide, and 8.5 ft tall. Other size steel ISO shipping containers can also be used. The grow module 400 is fully enclosed, with containment structure doors 405 at a each end that swing outwardly to provide access to an internal cavity 404. The first embodiment photosynthetic grow module is coated inside and out by a polyurethane enamel comprising insulating microspheres.

The removable cartridge 430 typically comprises a frame 431 including first members 432 and second members 434 supported by a cartridge base 440. Embodiments of first and second members include schedule 40 or schedule 80 three inch diameter PVC pipe. The first and second members of the fourth embodiment frame can thus be referred to as tubular frame members.

The frame 431 of the fourth embodiment is preferably about 70%-90% as long as the containment vessel 403 in which the removable cartridge 430 resides, and more preferably at least 80% as long. Accordingly, for a 20 foot containment vessel, the frame 431 is typically about 14-18 feet long, and is usually at least 16 feet long.

The cartridge base 440 is typically constructed from plate steel, and is capable of supporting the frame 431 and other cartridge components when the removable cartridge is lifted by a fork lift 446 engaging and lifting the cartridge base 440. Embodiments of cartridge bases include aluminum, other metals or metal alloys, or other rigid material structurally robust enough to support the cartridge frame 431 and other components. The removable cartridge 430 is readily removable as an intact unit from within the containment vessel 403 by use of a fork lift, crane, or other lifting device. The removable cartridge 430 is typically removed from within the container 403 for planting and for harvesting.

As best shown in FIG. 8, the first members 432 are typically oriented substantially vertically and the second members 434 are typically oriented substantially horizontally. Substantially vertically means oriented within 12° of vertical and substantially horizontally means oriented within 12° of horizontal. The first and second members are typically hollow and thus have channels 435 residing within. The channels are typically used for gas distribution. The gas is typically air or carbon dioxide (CO₂) supplemented air. Emission of air from within the frame 431 creates air flow, which typically reduces or eliminates fungal growth on plants 472 growing in the grow module. CO₂ supplementation can stimulate faster growth in some circumstances. CO₂ is typically supplemented to a level of about 1400 parts per million (ppm). In some embodiments, the air is supplemented with molecular oxygen (O₂) during dark intervals in the grow module, the O₂ supplemented air resulting in increased respiration by plants in the absence of photosynthesis. CO₂ or O₂ for supplementing air are typically, but not necessarily, provided by tanks 444 containing compressed gas.

Channels 435 of first and second frame members 432,434 are typically in fluid communication at intersections of the first and second frame members. The frame 431 is thus configured to distribute gas therethrough. The frame 431 further includes gas pores 437 in fluid communication with the channels, the pores being configured for emitting the gas at multiple locations about the removable cartridge 430.

As shown in FIG. 8, air or other gas is typically delivered to the removable cartridge 430 through a gas line 442 that receives gas under pressure from a gas pump 443. The gas pump 443 is typically an air pump and the gas is typically selected from the group consisting of air, CO₂ supplemented air, CO₂, or O₂ supplemented air. CO₂ or O₂ is typically provided from a compressed gas tank 444.

The removable cartridge 430 further comprises grow troughs 470 in which photosynthetic plants 472 are planted and grown, and from which the plants 472 are harvested. Embodiments include grow troughs 472 from Crop King, Inc. (Lodi, Ohio). Variations include grow troughs fashioned from PVC pipe, including three inch, two inch, or one and half inch schedule 40 or schedule 80 PVC pipe. Plant roots typically reside within the plant troughs 470 and are usually bathed in nutrient broth in a manner familiar to persons skilled in the art. The grow troughs 470 include plant apertures 413 through which the plants 472 extend as they grow.

As best shown in FIGS. 9 and 11, the frame 431 provides multiple levels 441A-441E for supporting the grow troughs 470, the multiple levels including a lower level 441A, and upper level 441E, a first intermediate level 441B, a second intermediate level 441C, and a third intermediate level 441D. The frame 431 acts as a support structure.

A nutrient broth is distributed to the grow troughs 470 through liquid conduits 460, a liquid distribution manifolds 462, and liquid distribution tube 464.

Any of the liquid conduits 460, the liquid distribution manifolds 462, or the liquid distribution tubes 464 can be referred to alone or collectively as cartridge liquid distribution plumbing. The cartridge liquid distribution plumbing 463 is operatively coupled to the grow troughs 470, which means the cartridge liquid distribution plumbing 463 is in fluid communication with the grow troughs 470 and is configured to deliver liquid to the troughs. The cartridge liquid distribution plumbing 463 is readily disconnected from the container liquid delivery plumbing 474, and also readily reconnected thereto, in order to facilitate ready removal of the removable cartridge 430 from the containment structure 403, and also ready installation therein.

Nutrient broth is typically delivered to the cartridge liquid distribution plumbing 463 from a liquid reservoir 418 through container liquid delivery plumbing 474. A liquid pump 419 typically provides positive pressure to the nutrient broth for delivery to the cartridge liquid distribution plumbing 463. The container liquid delivery plumbing 474 typically includes a liquid shut-off valve 475 and a connector 476 that facilitate ready disconnection or reconnection of the container liquid delivery plumbing 474 from or with the cartridge liquid distribution plumbing 463. The connector 476 is typically a threaded connector, quick-disconnect fitting, or similar device adapted to ready disconnection and connection

Nutrient broth typically drains from within the grow troughs 470 through a cartridge drain assembly 465, which in turn drains into a container drain line 469. The cartridge drain assembly 465 is connected from the container drain line 469 with a drain connector 466. The drain connector is typically a threaded connector, quick-disconnect fitting, or similar device adapted to ready connection and disconnection.

The removable cartridge 430 further includes cartridge light fixtures 490 for irradiating the plants 472 with light, including ultraviolet light, visible light, or infra-red light. The cartridge light fixtures typically include T-8 fluorescent lamps or LEDs. Cartridge light figures can also include metal-halide and high pressure sodium lamps.

Among its emitted light, the fluorescent lamps typically provide ample amounts of blue light equivalent to about 6500° K. The 6500° K light typically promotes vegetative growth and can encourage compact, leafy development in lettuce and other leafy plants.

The LEDs typically provide red light equivalent to about 3000° K. The 3000° K light typically promotes increased budding and flowering and is more important for mature plants. The red light can also promote vertical growth in plants.

Embodiments of cartridge light fixtures 490 are configured to adjust vertically in order to maintain a desirable height above the plants as the plants grow taller. Variations include cartridge light fixtures that move horizontally during normal operation. The horizontal movement provides light incident upon plants at varying angles, which can benefit plants by, among other things, reducing shadowing. The horizontal movement can also reduce the number of fixtures required for optimal illumination, which can reduce capital costs and energy consumption.

### A Fifth Embodiment Photosynthetic Grow Modules

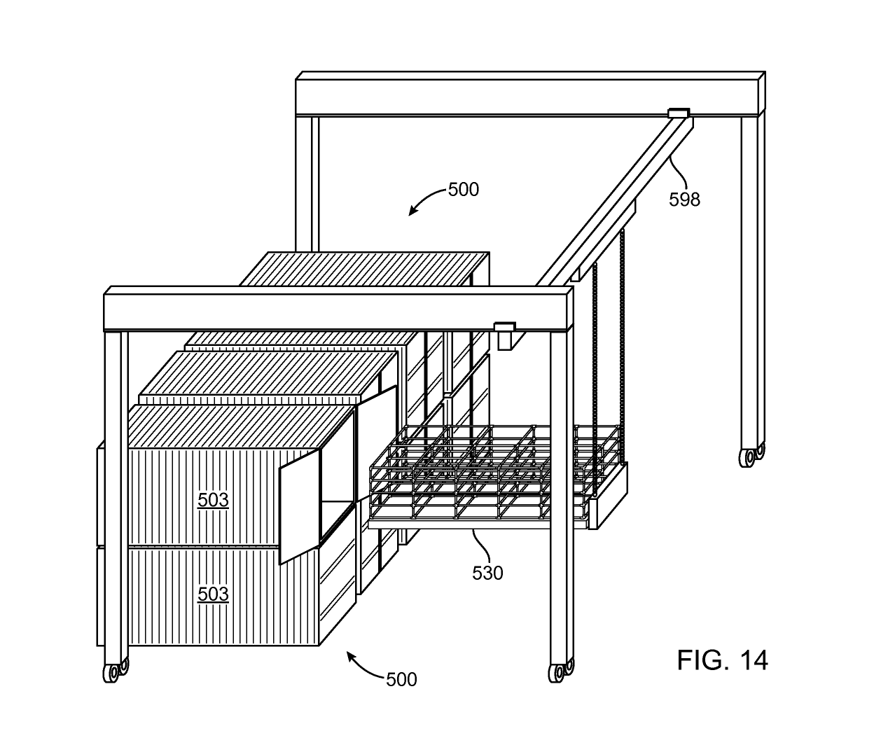

Fifth embodiment photosynthetic grow modules 500, stacked two modules high inside a warehouse, and are illustrated in FIG. 14. The fifth embodiment grow modules 500 comprise containment vessels 503 and removable cartridges 530 for growing plants hydroponically within the containment vessels 503. Installing and removing the removable cartridges 530 in and from the containment vessels, respectively, and transporting the removable cartridges 530 within the warehouse, are typically performed using a crane 598. The crane 598 can be a gantry or overhead crane. The containment vessels 503 of the fifth embodiment are adapted to stack seven vessels high without requiring additional support or scaffolding. In some embodiments, operation of the crane is fully automated and is performed according to instructions stored on a non-transitory machine readable medium. Variations include cranes controlled by human operators in real time.

### A Method of Using a Photosynthetic Grow Module

A method of using the fourth embodiment photosynthetic grow module includes operations described below. A first operation comprises opening the doors of a containment vessel in order to remove the removable cartridge. Swinging doors on both ends of the containment vessel are typically opened during the first operation. During normal grow operations; the containment vessel can be kept closed with the removable cartridge and plants fully enclosed within. Air exchange can by accomplished through a HEPA filter, and nutrient broth is piped into and out of the containment vessel through ports in the vessel that are sealed to prevent air exchange or entry into the containment vessel by insects or other pests, stray seeds, or fungal spores, or other pests. Accordingly, plants can be grown within the containment vessel without pesticides, herbicides, or fungicides.

A second operation comprises disconnecting the removable cartridge from the containment vessel. Said disconnecting typically includes: (i) using the liquid cut-off valve to interrupt nutrient broth flow to the cartridge liquid distribution plumbing; (ii) disconnecting the container liquid delivery plumbing from the cartridge liquid distribution plumbing; (iii) disconnecting the container drain line from the cartridge drain assembly (iv) disconnecting the gas line from removable cartridge, and (v) disconnecting the cartridge light fixtures from the electric power source. Performing the second operation leaves the removable cartridge disconnected from the containment vessel within which it resides, and thus configured to be removed therefrom.

A third operation comprises removing the removable cartridge from within the containment vessel and placing the removable cartridge at a work station outside the vessel. The third operation is typically performed with a fork lift that reaches into the containment vessel, engages the base of the removable cartridge, lifts the removable cartridge, and removes the cartridge from the vessel. The fork lift subsequently delivers the removable cartridge to a work station where harvesting personnel are ready to harvest plants from the grow troughs. The work station typically resides inside a warehouse or other structure that also houses the grow module or multiple grow modules. In some embodiments, particularly where multiple grow modules are stacked two or more high, an overhead crane is used to remove grow modules from containment vessels, and to transport removable cartridges between work stations and containment vessels. In some embodiments, removable cartridges include wheels, castors, dollies, or the like, for moving the removable cartridges into and out of containment vessels.

A fourth operation comprises harvesting the plants, which typically includes plucking the plants, roots and all, from the grow troughs. Harvesting the plants is much more readily performed when harvesting personnel are free from the confines of the containment vessel.

A fifth operation comprises transplanting seedlings or other young plants into the grow troughs, a task that is much easier when performed outside the confines of a containment vessel.

A sixth operation comprises installing the removable cartridge in the containment vessel. The sixth operation is typically performed using a fork lift to transport the removable cartridge from the work station to the containment vessel and to place the cartridge in the vessel. Variations include overhead cranes for lifting and transporting removable cartridges.

A seventh operation comprises connecting the removable cartridge to the containment vessel in which the removable cartridge has been installed. Said connecting the removable cartridge includes: (i) connecting the cartridge light fixtures to the electric power source and illuminating the young plants; (ii) connecting the gas line to the removable cartridge and delivering air or other gas through the gas line to the cartridge; (iii) connecting the container drain line to the cartridge drain assembly; (iv) connecting the container liquid delivery plumbing to the cartridge liquid distribution plumbing; and (v) opening the liquid cut-off valve to resume nutrient broth flow to the cartridge liquid distribution plumbing.

### An Embodiment of a Photosynthetic Grow Module System

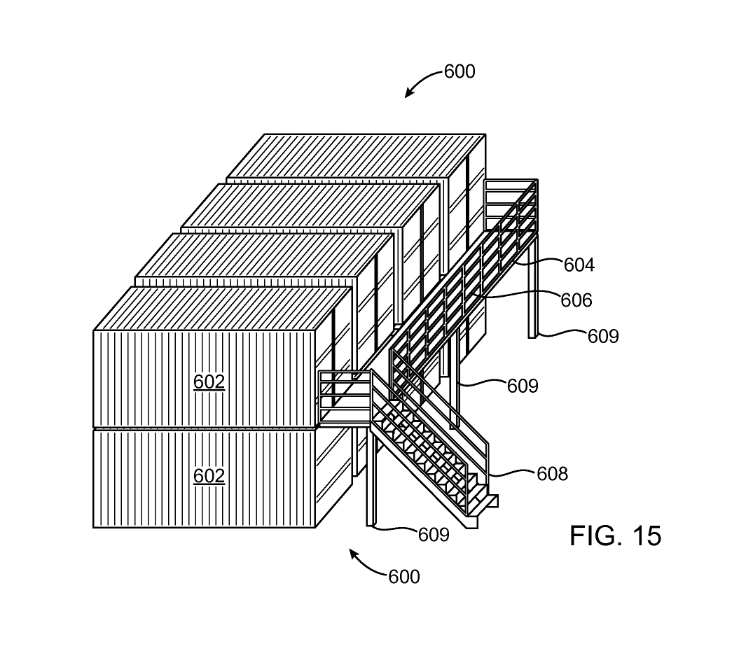

Referring to FIG. 15, an embodiment of a photosynthetic grow module system 600 is illustrated. Generally, the grow module system 600 can include a plurality of grow modules stacked together inside a warehouse.

In one embodiment, the grow module system 600 can include a plurality of containment vessels 602 and a mezzanine 604. The containment vessels 602 can be implemented for growing plants within a warehouse. Generally, the containment vessels 602 can be stacked one on top of another and right next to each other, as shown in FIG. 15. For instance, a plurality of containment vessels 602 can be stacked two high in a row.

The mezzanine 604 can be implemented to provide access to a second level of containment vessels 602. In one embodiment, the mezzanine can include a staircase 608 and one or more extensions 606. The staircase 608 can be implemented to access a floor of the mezzanine. In some embodiments, an elevator or lift can be implemented to provide access to the mezzanine floor. In one instance, a manually powered lift can be implemented to access the mezzanine floor.

Generally, the mezzanine 604 can be modular so that as more containment vessels 602 are stacked together, the mezzanine 604 can be lengthened. For instance, as more containment vessels are added, more extensions 606 can be added. Typically, the extensions 606 can include one or more support structures 609 depending on a length of the extension. In some embodiments, the extensions 606 can span one or more containment vessels 602. For instance, one extension 606 may span four containment vessels and include two support structures 609. In another instance, the extension 606 may span two containment vessels. It is to be appreciated that the extensions 606 can be adapted to span one or more containment vessels depending on an implementation.

Typically, the mezzanine 604 can run a length of the containment vessels 602 and can be removably coupled to each of the containment vessels. For instance, the mezzanine 604 can include flanges that insert into holes of each of the containment vessels. In some embodiments, the mezzanine 604 can include a plurality of staircases and/or lifts.

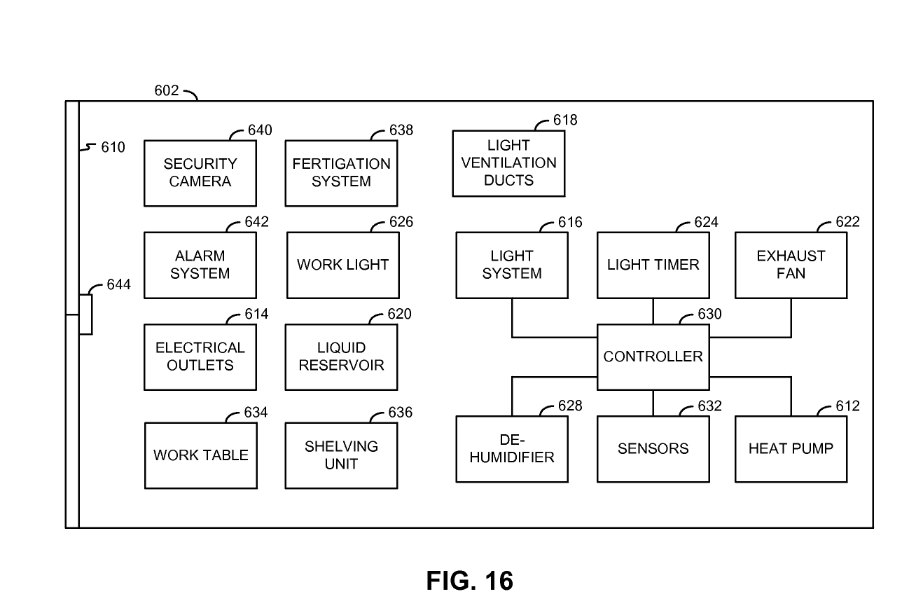

Referring to FIG. 16, one embodiment of a containment vessel 602 that can be implemented in the grow module system 600 is illustrated. The containment vessel 602 can generally include a containment structure comprising a 40 foot steel ISO container having external dimensions of approximately 40 ft long, 8 ft wide, and 8 ft tall, and having an internal cavity with a volume of approximately 2232 ft³. It is to be appreciated that other ISO containers can be implemented in the present embodiment. Typically, the containment vessel 602 can be fully enclosed. In one embodiment, the containment vessel 602 can include swinging doors 610 similar to the swinging doors 305 of the third embodiment grow module. The swinging doors 610 can be implemented at a first end of the containment vessel to provide access to an internal cavity of the containment vessel. For instance, the swinging doors 610 can be push bar doors. It is to be appreciated that other types of doors can be implemented without exceeding a scope of the present invention.

In one embodiment, the containment vessel 602 can include a heat pump 612 and one or more electrical outlets 614. The heat pump 612 can be implemented for heating and cooling the internal cavity of the containment vessel 602. In one embodiment, the heat pump 612 can be a mini-split wall mounted air conditioner/heat pump. Typically, highly efficient heat pump systems can be implemented in the containment vessel 602. The electric outlets 614 can be implemented as a source of electric power. Generally, the electrical outlets 614 can be connected to an external power source. For instance, the electric outlets 614 can be connected to a power source of the warehouse.

In addition to the heat pump 612 and electrical outlets 614, the containment vessel 602 can include a light system 616. In one embodiment, the light system 616 can include multiple light sources. Typically, one or more different types of light sources can be implemented. Each of the light sources typically comprises a high intensity discharge lamp. In one embodiment, the light system 616 can include light ventilation ducts 618 for removing heat generated by the high intensity discharge lamps. The high intensity discharge lamps can be hard-wired for delivery of electric power, or can be plugged into an adequately powered electric outlet. For instance, the light sources can be plugged into the electrical outlets 614 included in the containment vessel 602.

To provide insulation, the containment vessel 602 can include an interior coating comprising ceramic microspheres having a low pressure internal cavity and aluminum flakes, both of which can be embedded in a latex paint. The ceramic microspheres conduct heat extremely poorly and the aluminum flakes are highly reflective of infra-red electromagnetic radiation. The interior coating of the containment vessel 602 can act as an efficient heat conductive barrier and radiant barrier. Generally, the exterior can be coated with a paint having ceramic microspheres acting as in insulator.

In one embodiment, the containment vessel 602 can include a liquid reservoir 620 adapted to contain nutrient broth for hydroponic cultivation of green plants in the containment vessel 602. For instance, a plurality of containers or troughs can be connected to the liquid reservoir 620. In another embodiment, the liquid reservoir 620 can be implemented to store a gas/nutrient mixture for aeroponic cultivation. For instance, the liquid reservoir 620 can be connected to a plurality of nozzles adapted to spray roots of plants being grown in the containment vessel 602.

Generally, the containment vessel 602 can include a plurality of devices adapted to aid growing plants in the containment vessel. For instance, the containment vessel 602 can include, but is not limited to, an exhaust fan 622, an automatic light timer 624, a work light 626, a de-humidifier 628, a programmable logic controller 630, one or more sensors 632, a work table 634, a shelving unit 636, and a fertigation system 638. It is to be appreciated that the containment vessel 602 can include one or more of each of the previously listed devices.

In one embodiment, one or more of the previously listed devices can be connected to the programmable logic controller 630. For instance, the heat pump 612, the light system 616, the exhaust fan 622, the automatic light timer 624, the one or more sensors 626, and the de-humidifier 628 can all be connected to the programmable logic controller 630. Generally, each of the devices attached to the general logic controller 630 can be automated.

In some embodiments, the programmable logic controller 630 can be connected to a network. In such an embodiment, the logic controller 630 can be remotely accessed. For instance, a user may remotely access the logic controller and alter lighting conditions. In another instance, a user may remotely change the temperature in the containment vessel by activating the heat pump 612. In yet another instance, a user may remotely program the automatic light timer.

To secure a containment vessel, one or more security features can be implemented. For instance, a closed circuit security camera system 640, an alarm system 642, and a commercial locking mechanism 644 can be implemented with each containment vessel 602. In some embodiments, one or more of the security features can be connected to the logic controller 630. It is to be appreciated that the security features can be independent of the logic controller 630.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

Embodiments are contemplated where multiple grow containers are connected to a centralized control container. The control container can include, but is not limited to, (i) a liquid reservoir adapted to contain nutrient broth for each of the grow containers, (ii) a heat pump for heating and cooling each of the grow containers, (iii) electrical outlets providing electrical power for each grow container, and (iv) tanks containing CO₂ and/or O₂ for supplementing air in the grow containers. It is to be appreciated that some of the components can be housed in the grow containers. In an embodiment, conditions in each of the grow containers can be adjusted from the control container.

In an embodiment, each of the grow containers are independently connected to the control container. It is to be appreciated that other configurations between the control container and each of the grow containers is contemplated.

I claim:

1. A photosynthetic grow system comprising:
a plurality of containment structures, each of the plurality of containment structures including an ISO shipping container;
a mezzanine removably coupled to the plurality of containment structures; and
a grow assembly inside each one of the plurality of containment structures, each grow assembly including:
a plurality of light sources;
a light ventilation duct adapted to remove heat generated from the plurality of light sources; and
a heat pump adapted to heat and cool an interior of the containment structure;
wherein each of the plurality of containment structures includes at least one security feature.

2. The grow system of claim 1, wherein the plurality of containment structures are stacked two high in a row.

3. The grow system of claim 2, wherein the mezzanine allows access to a second level of containment structures.

4. The grow system of claim 3, wherein the mezzanine includes a staircase to the second level of containment structures.

5. The grow system of claim 3, wherein the mezzanine includes a manual lift.

6. The grow system of claim 1, wherein each of the plurality of containment structures include one or more sensors.

7. The grow system of claim 6, wherein the one more sensors are adapted to monitor conditions inside the containment structures selected from a group consisting of relative humidity, air temperature, and CO₂ concentration.

8. The grow system of claim 1, wherein at least one of the plurality of containment structures are a reclaimed ISO shipping container.

9. The grow system of claim 1, wherein each of the containment structures include a pair of swinging doors.

10. The grow system of claim 1, wherein an interior of each of the containment structures are coated with a paint having ceramic microspheres and aluminum flakes.

11. The grow system of claim 10, wherein an exterior of each of the containment structures are coated with a paint having ceramic microspheres.

12. The grow system of claim 1, wherein the plurality of light sources includes high intensity discharge lamps.

13. The grow system of claim 1, wherein the heat pump is a high efficiency mini-split HVAC unit.

14. The grow system of claim 1, wherein the grow assembly further includes one or more circulation fans.

15. A photosynthetic grow system comprising:
a plurality of containment structures stacked two high in a row, each of the plurality of containment structures including an ISO shipping container;
a mezzanine removably coupled to the plurality of containment structures, the mezzanine including at least one staircase and providing access to a second level of containment structures; and
a grow assembly inside each one of the plurality of containment structures, each grow assembly including:
a plurality of light sources including high intensity discharge lamps;
a light ventilation duct adapted to remove heat generated from the plurality of light sources;
a high efficiency mini-split HVAC unit adapted to heat and cool an interior of the containment structure;
one or more sensors;
wherein each of the plurality of containment structures includes at least one security feature.

16. The grow system of claim 15, wherein each of the plurality of containment structures include a security camera system.

17. The grow system of claim 16, wherein each of the plurality of containment structures further include a commercial locking mechanism.

18. The grow system of claim 15, wherein the grow assembly further includes automatic light timers.

19. The grow system of claim 19, wherein the automatic light timers can be remotely set.

20. A photosynthetic grow system comprising:
a plurality of containment structures stacked two high in a row, each of the plurality of containment structures including an ISO shipping container having (i) an interior coated with a paint having ceramic microspheres and aluminum flakes and (ii) an exterior coated with a paint having ceramic microspheres;
a mezzanine removably coupled to the plurality of containment structures, the mezzanine including at least one staircase and providing access to a second level of containment structures; and
a grow assembly inside each one of the plurality of containment structures, each grow assembly including:
a plurality of light sources including at least one high intensity discharge lamp;
light ventilation ducts adapted to remove heat generated from the plurality of light sources;
a high efficiency mini-split HVAC unit adapted to heat and cool an interior of the containment structure;
one or more sensors adapted to monitor conditions inside the containment structure selected from a group consisting of relative humidity, air temperature, and CO₂ concentration; and
an automatic light timer adapted to turn the plurality of lights sources on and off.
